(19) United States
(12) Patent Application Publication
(10) Pub. No.: US 2006/0263561 A1
(43) Pub. Date: Nov. 23, 2006

(54) Prime label intermediate having a glossy appearance and produced from a continuous process

(76) Inventors: Roger E. Kraft, Fort Scott, KS (US); Jesse D. Crum, Fort Scott, KS (US); William R. Russell, Pittsburg, KS (US)

Correspondence Address: WARD/KRAFT, INC., 2401 COOPER STREET, P. O. BOX 938, FT. SCOTT, KS, 66701, US

(21) Appl. No.: 11/183,458

(22) Filed: Jul. 18, 2005

Related U.S. Application Data
(63) Continuation-in-part of application No. 11/135,481, filed on May 23, 2005.
Application No. 11/135,481 is a continuation-in-part of application No. 11/135,179, filed on May 23, 2005.
Application No. 11/135,179 is a continuation-in-part of application No. 11/135,131, filed on May 23, 2005.

(51) Int. Cl. B32B 33/00

(52) U.S. Cl. 428/40.1; 428/42.2; 428/42.3

(57) ABSTRACT

The present invention relates to the production of a glossy, prime label pressure sensitive laminate assembly having high quality graphical depictions. More particularly, the specification describes a process in which individual segments are prepared by printing or imaging areas of a sheet with discrete indicia, preferably by using a high quality imaging device that produces graphical depictions on the surface of the sheet. The sheets are then cut or separated into prime label ribbons or segments, with each segment containing printing, and then the segments or ribbons are placed on a continuously advancing web to produce a web having discrete pre-printed ribbons or segments applied thereto. A glossy film is then placed over the segments and sealed or laminated to the surface of the segments to produce a glossy prime label assembly. The laminated web may then be cut into individual sheets to create sheets that have one or more prime label ribbons disposed thereon.

### CROSS-REFERENCES TO RELATED APPLICATIONS

This application is a continuation-in-part of application Ser. No. 11/135,481 filed May 23, 2005, Ser. No. 11/135,179 filed May 23, 2005 and Ser. No. 11/135,131 filed May 23, 2005 the disclosures of each of which including that found in the claims is incorporated herein by reference.

### FIELD OF THE INVENTION

The present invention is in the field of composite, intermediate manufacturing methods that are used in the preparation of articles, such as pressure sensitive laminates, intended for use as a prime label. More particularly, such laminated assemblies may be used in the production of prime label products having a glossy appearance.

The present invention is used to produce business and marketing communications that are manufactured in a unique and continuous process. The instant specification includes providing a continuous web of a material, then applying a number of discrete, previously prepared and high quality, pre-printed segments over the top of the web to create an intermediate assembly that may be further processed, such as by die cutting, to produce communications that can be used to convey information or aid in developing or advancing a promotion.

The segments, which represent an area of printable stock material, are produced in part, initially from a pre-imaged or pre-printed sheet that is then cut, converted or merged to a roll type of format through use of a placer mechanism that sequentially places the cut pieces on the web to create a partially laminated assembly.

The sheets are preferably printed with high quality graphics or images which are then slit or cut to size (regular and irregular shapes) to form templates, ribbons, surface elements or segments for the particular application. The segments are then converted to or merged with a continuously advancing web to create a continuous, laminate roll format that is then over laminated with synthetic film stock to create a glossy appearance. The segments that have been affixed to the web are provided in one or more intermediate laminated configurations to an end user. By using the process of the present invention high quality graphics can be prepared to further enhance the particular offering that is being created. More particularly, the pressure sensitive intermediate of the instant application can be used to create individual, prime label products having a high or photo quality resolution level such as those about 300 lines per inch or approximately 2500 to 3500 dots per inch.

### BACKGROUND OF THE INVENTION

Today, there are wide varieties of product offerings available that serve multiple purposes and functions, including product offerings that are used in fulfilling needs in the prime label market. Conventional processes that are used today in creating prime labels are typically based on a continuous web technology using flexographic presses. The process includes the feeding of a continuous web of material, such as a preformed web of pressure sensitive laminate, which normally consists of a top ply having a layer of adhesive on its underside that is covered by a release liner to form the laminate assembly through the press. The web is then processed through a press, typically a flexographic press, and an image is applied to the web by various stations. The web may then be collected, die-cut and the individual labels removed and applied.

Prime labels having a glossy appearance may also be produced in which an “optically clear” product is created. In this process, a film liner is provided with a substantially transparent adhesive, and the liner is positioned over the prime label substrate and through the use of the adhesive, the liner is temporarily affixed to the label substrate. The liner, which acts as a release liner or material, is then stripped away and a clear polyethylene sheet (PET) is applied over the top of the adhesive. Ideally, the positioning of the film is done so as to not create any bubbles or other imperfections in the surface of the label. Obviously, such a process can create surface distortions as well as create additional steps in the manufacture of such products, which may be costly and reduce the number of potential applications for which the prime label products may be utilized.

Flexography is commonly used today for the production of prime label substrates as well as for the printing of decorative items, including the rendering of packaging. The technology employs a series of plates and one or more stations, containing inks (usually a different colored ink at each station), to apply colored images to the web as the web traverses the press. Through improvements in ink qualities and other modifications and enhancements in the technology, the image quality in flexographic presses and resulting products has improved to about 150 lines per inch.

For a point of reference, typically, screens that have rulings of about 60 to 100 lines per inch are normally used to make halftone printed images for newspapers. Screens with about 120 to 150 lines per inch are commonly used today to produce images for magazines and commercial printing. Such screens are regularly produced by electronic dot generation.

Electronic dot generation is normally performed by computers that use unique screening algorithms, in cooperation with electronic scanners and image setters, to produce halftone images that are to be subsequently used to render an image. The pixels of digitized images are first assembled into dots that are then used to form shapes, sizes, rulings, etc. which create the ultimate image produced on the substrate.

While flexographic technology or flexography is desirable for use in such printing, due to the economies that can be achieved when compared with other types of printing processes, such as lithography, there are a number of drawbacks in utilizing this process for certain applications. Initially, the quality is limited, despite improvements in the technology to about 150 lines per inch. This can make some complicated graphics appear “grainy” or other images, such as those that use flesh tones or deep or rich colors, look faded or “washed out”. The effects of this level of image resolution can detract from the product appearance which may diminish the value of the technology and the products produced particularly for the prime label market. With increasing sophistication of consumers, as well as technology and expectations from each, such effects may be undesirable to potential end users.

Flexography also suffers from other drawbacks, such as the time involved in preparing a job to run or “make ready” as it may otherwise be known. That is, the steps that are used to prepare the flexography equipment for running a particular job or order. This make ready includes such activity as the preparation of multiple plates to produce the image at each station, mixing inks, calibration and alignment of the images between stations and the like. Operation of the flexography presses may also include multiple operators, which can add to manufacturing costs.

Waste can also be a problem with such conventional printing technologies in that a number of feet, yards or meters of web material must be processed through the press in order to have the colors reach a predetermined threshold and to ensure appropriate registry of the stations as they are printing the images on the web. The amount of material wasted can be several times the length of the press or up to several hundred feet of material. The use of such volumes of materials obviously increases the cost of the operation. Thus, due to the make ready and waste factors, the production of products, such as prime labels, using flexography may then be limited to serving only certain market segments, namely large market segments.

Another drawback believed to be associated with flexographic technologies is that the technology may not be able to provide any variability in the product, including such basic functionality as sequential numbering, addressing or adding promotional text in connection with a seasonal advertisement or other offering without the addition of further processing stations and investment in equipment. If such features are required by an end user or customer, such as with product date or coding, this function generally cannot be performed by flexographic presses without the inclusion of additional stations and instead typically must occur through an off line operation, such as in an ink jetting operation, often after the label web has been removed from the press and the individual labels have been applied to the container or carton. Alternatively, the ink jetting may be performed directly on the container as part of a separate operation.

Flexographic presses normally have a number of pre-determined stations. For example a four color press may have only four stations that can be used to treat or process the web. Thus, if other stations are to be added, such as a numbering head, the manufacturer likely then has to reduce the number of colors that can be added to the web, as one station has been surrendered for the numbering head.

Flexographic technology also limits the ability to add personalization to products produced on such presses. This may be particularly desirable in certain market segments such as prime label products on consumer package goods (“CPG”), which may further enhance the product or service offering by making the product more attractive to prospective purchasers, thereby increasing the appeal to the consumer of the product or service.

Identifiers such as labels or tags may also be readily rendered using desktop equipment. While the resolution may be slightly improved when compared with conventional flexographic technology, speeds of application are significantly reduced as the images are processed in a sheet wise fashion on desktop equipment resulting in only a few sheets per minute as opposed to hundreds of feet per minute that are capable of being processed by flexographic equipment. That is, the desktop unit may only handle and print one sheet at a time before the next sheet is advanced for printing or imaging when compared with a conventional web fed process. Thus, in using such a desktop process one may only be able to render a handful of sheets per minute as opposed to a flexography operation that may process several hundred feet per minute. Use of desktop processes is thus not likely efficient in trying to generate hundreds and certainly not thousands of labels, but may be useful in creating a few dozen labels for very small applications such as a small home or small office environment.

What is needed, therefore, is a method by which a glossy label substrate can be produced with high quality graphics for prime label applications. Such a label would ideally have a resolution that is in excess of at least about 150 lines per inch and which can be manufactured in an efficient and cost effective manner, such as in a continuous system operating at greater than fifty feet per minute. Moreover, a method which can add substantial variability to the product as well as other features, such as embossments, over laminates, variable printing, additional elements or imaging and the like, would greatly expand the penetration of this form of business communication in the marketplace.

The present invention seeks to provide a method for producing an innovative prime label intermediate having a quality of about 150 or more lines per inch and preferably more than 300 lines per inch, which is approximately equal to about 2500 to 3500 dots per inch (“DPI”), in order to create a high quality image that is intended to be aesthetically appealing to the consumer. The prime label intermediate may be cut into individual sheets or shaped sheets to further add to this unique offering.

Through the development of the present system and the creation of the unique intermediate web assembly described in this invention, the manufacturer can now service a particular niche market segment for creating high quality templates in a continuous fashion, such as those ranging from approximately 100 to 1,000,000. While the foregoing market size or segment is a target area of the present invention, it should be appreciated that the invention may be practiced and used to fulfill larger order quantities, such as those of a million or more.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Unexpectedly, it has been discovered that there is no readily available process or system by which a manufacturer can create high quality, glossy prime labels having significantly improved graphic resolution that is greater than at least about 150 lines per inch, preferably greater than about 200 lines per inch and still more preferably about 300 lines per inch, in an efficient and cost effective manner. The development of the present system, process and the creation of the unique intermediate web assembly described in this invention permit the servicing of a particular niche market segment for glossy prime labels, that of approximately 100 to 1,000,000 prime labels. While the foregoing market size or segment is a target area of the present invention, it should be appreciated that the invention may be practiced and used to fulfill larger order quantities, such as those of a million labels or more.

The pressure sensitive intermediate of the present invention is created through a unique sheet to roll process which provides savings when compared with conventional flexography processes, specifically through reduced make ready time and generation of waste material. In addition, through practice of the present invention the resulting process yields an intermediate product having a higher image resolution product when compared with conventionally produced prime label constructions.

The present invention uses previously prepared individually created sheets, or segments, that have high resolution imaging or printing already applied to the sheets, e.g. graphical depictions, before the sheets are provided to the manufacturing press. The sheets, ribbons or segments may be applied to the web in a number of patterns, including substantially edge-to-edge configuration, with a slight overlap or alternatively, provided in regularly occurring increments depending on the needs of the particular application to be serviced. In addition, the product produced in connection with the present process described in the instant application is not limited in functionality as a number of materials, operations and options may be used in creating a relatively dynamic product. Such additional processes may include variable printing, embossments, coatings, over laminates and the like.

By preparing the intermediate prime label assembly in the manner described herein, the intermediate web can be processed continuously at speeds of greater than 50 feet per minute, preferably between 75-150 feet per minute and still more preferably at speeds of about 200 feet per minute or greater.

In one exemplary embodiment of the present invention, a glossy prime label produced in accordance with the following process, is described and includes the steps of initially producing a plurality of individual sheets with areas that have distinct graphical depictions provided on at least one face of each of the sheets. Next, a continuous web is advanced having first and second faces and first and second longitudinally extending sides, a release coating is applied over the first face and a pattern of adhesive is applied over the release coating. The web will serve as a carrier web for the prime label segments and will function as a release liner when the segments are later removed.

Each of the sheets are cut or trimmed to create at least one prime label segment from each sheet with each segment containing the distinct graphical depiction. Each segment is then placed on the pattern of adhesive in a substantially abutting edge-to-edge relationship and between the first and second longitudinally extending sides of the continuous web. A synthetic film is placed over each of the segments and may be secured to the surface of the segments through use of a heated roller that seals the film to the prime label segment. After the film is sealed to each of the segments a continuous web is created that has a regularly occurring series of glossy prime labels affixed to the surface thereof.

In a still further exemplary embodiment of the present invention, a glossy prime label intermediate assembly that is produced in accordance with the following process is described and includes, initially printing a number of areas on individual sheets with distinct textual and graphical depictions. Then a glossy film material is applied over each of the sheets and each of the sheets are cut into discrete ribbons, with each ribbon including at least one printed area. Each ribbon will then have the distinct textual and graphical depictions that were provided on the sheet and each ribbon will have a matrix portion and a prime label portion. A group of the ribbons that have been prepared as described above will be placed into a mechanical feeder. Then a continuous web is advanced beneath the mechanical placer mechanism with the web having a previously applied pattern of adhesive applied over a release coating. Each of the ribbons with the film thereon is applied to the web in a sequential fashion so that the ribbons will be in contact with the adhesive. The web is then collected to create an intermediate glossy prime label web assembly having a discontinuous series of glossy prime labels disposed thereon.

In yet a still further exemplary embodiment of the present invention, a prime label intermediate web assembly that has intermittently positioned glossy prime label segments disposed thereon is described and includes a continuous web of material, the web of material having a pattern of pressure sensitive adhesive disposed on a surface of the web. The presently described embodiment includes a series of preprinted, individual segments that have an area less than an area of the continuous web. The individual segments are placed on the continuous web over the pattern of adhesive in a discontinuous, incremental arrangement and in a substantially edge-to-edge relationship to one another. A glossy film stock is affixed to a surface of each of the segments to produce a glossy prime label intermediate.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a schematic of an apparatus used in preparing the glossy prime label intermediate web assembly as described herein;

FIG. 2 provides a top view of a glossy prime label web assembly prepared in accordance with the present invention;

FIG. 3 shows cross sectional view of the glossy prime label web assembly depicted in FIG. 2; and

FIG. 4 illustrates a block diagram showing an exemplary method of practicing the present invention in preparing a glossy prime label intermediate web assembly.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

The term “prime label” as used herein refers to a label or other identification piece that may be used interchangeably with labels, such as tags, typically having a pattern of adhesive disposed on one side of a substrate and one or more graphical illustrations or depictions on the opposite side. Some level of textual messaging may also be provided on the face of the label. The adhesive is typically a pressure sensitive adhesive but may also include activatable adhesives such as thermally or moisture sensitive materials. However, it should be understood that all prime labels need not be provided with an adhesive.

Prime labels are further distinguished from other labels in the art in that such labels are known as having a high level of quality or value. The term prime label is often used to describe a type of label that is the highest grade marketed in a particular industry. Prime labels find application in a number of exemplary areas but have found wide range acceptance particularly in the area of consumer packaged goods (“CPG”) and other products for which the prime label is an effective means for communicating a specific message or for enhancing the image of the manufacturer or distributor or presenting the product as a high quality item. Prime labels are also used for business communications in that they can convey certain desirable criteria, image, brand recognition or information and can be used independently of a product, such as in connection with advertising a service opportunity or offering, or with other activities or undertakings, such as non-profit organizations.

Prime labels, particularly prime labels prepared in accordance with the present invention, may also contain printed messages, including personalized and/or variable information in addition to the graphical displays. The printed messages can be fixed or static, as will be explained herein, may be personalized or sequentially numbered or provided with other unique or special identifiers.

The term “patterns” as used herein refers to strips, lines, shapes, spots, dots, elements and discontinuous segments, as well as regular and irregular placement of such items. Patterns may also refer to combinations of the above-mentioned items such that one pattern may be a continuous strip; another, segmented elements; and a still further irregular placement of elements or the like. Any combination of patterns is possible depending on the need or application of the manufacturer or the end user. In addition, the pattern can be prepared in order to accommodate a particular theme, season, event, trade dress, graphics, alpha and numeric characters, and the like. Patterns are used in connection with the present invention to describe the placement of the label segments or ribbons applied to the web or individual prime labels positioned on the web in a particular pattern or arrangement. Pattern as defined herein also is used in connection with the adhesive that is applied to the continuous web.

As used herein, the term “business communication piece or document” refers to a substrate that, either alone or in combination with other documents, can convey a particular message or image or provide information about a particular product or service that is available from the provider of such pieces or documents. Business communication documents or pieces can include advertising, sales and marketing collateral and such other items used to convey information on written or imaged form sheets, brochures, presentation folders, informational sheets and combinations thereof.

The term “personalized information” refers to information that is printed or imaged onto a substrate, which is generally variable or unique and which may change from document to document or segment to segment so as to create a customized message or communication for each recipient. Examples of personalized information may include names, addresses, descriptions, plans, coding, numbering, promotional text, etc. that may have been acquired from the intended recipient through surveys, questionnaires or answers given to various inquiries generated in response to a request for goods or services.

The term “static or fixed” information refers to printed or imaged information that generally does not change from document to document or segment to segment and may include a general description or body of information about particular products, services, places, etc. that may be of interest to the intended recipient and represents a standard message that the manufacturing or supplier wishes to convey to an end user or customer of the offering.

The term “intermediate” as used herein refers to a product that undergoes one or more processing steps prior to the intermediate reaching a final condition, that of being ready for end use or application. The additional processing steps may include printing, imaging, folding, sealing, separating, cutting, perforating, scoring, adhering and the like. Typically, a product such as with the present invention is provided in an intermediate condition so that a user can add or manipulate the intermediate to create the final or desired end product, such as applying the prime label to a container, carton or the like. Thus, in accordance with the present invention, the intermediate segment, for example, could be subject to die cutting or additional printing, such as through ink jetting, over laminating, coating or embossment, and then applied to a container, carton, consumer package good or the like.

The term “sheets” or “segments” as used herein refers to sheets, segments, ribbons, strips, pieces, parts, sections, subdivisions and combinations thereof. The sheet or segment provided as an example for the purposes of this specification can be an entire sheet such as 8½″×11″, 11″×14″, 19″×25″ and other known sheet sizes or may be segments, divisions, strips, etc. of such sheets. For example, a 19″×25″ sheet may be produced with five rows of labels, with each row having six labels, with each label having dimensions of approximately 3″×4″. For instance, in this example, each row may comprise an individual segment or sheet that may be used in practicing the present invention. It should, however, be understood that the invention is not to be so limited to the foregoing configuration that individual pieces or elements, regardless whether the piece or elements have a regular or irregular shape, may be used in connection with this process to produce the intermediate assembly that is described in this application.

The glossy film stock that is used in accordance with the present invention is a clear polyethylene film that is laminated to the prime label segments either through the use of adhesive or alternatively by a heated roller that may shrinks and seal the film directly over the surface of the prime label segments or activate the adhesive to adhere the adhesive to the segment. The film may also be pre-printed with indicia using the same high quality resolution imaging device as that used to print the sheets of material that will become the prime label segments. The printing may be complimentary to the printing on the sheets, for example a pictorial overlay that accentuates the textual image provided on the surface of the segments, so as to form a complete message.

In addition, the film stock can be partially transparent or clear and partially opaque or substantially translucent. The film may be applied in a continuous fashion over the surface of the web or alternatively, the film may be cut into individual pieces or segments with each segment being sized and configured to be about the size of the label segment.

An exemplary high resolution imaging device that is used in preparing the areas of the sheets that will become the prime label segments as well as the film, if the film is preprinted, used to cover the segments in accordance with the present invention includes an Indigo®, available from Hewlett Packard of Palo Alto, Calif. or Karat available from KBA of Williston, Vt. The present invention seeks to provide a prime label segment or intermediate that has a quality of at least about 150 or more lines per inch and preferably more than 300 lines per inch, which is approximately equal to about 2500 to 3500 dots per inch (“DPI”) in order to create a high quality image that is intended to be aesthetically appealing to the consumer.

An exemplary placer, feeder or insertion device that is used in the practice of the present invention is a Maverick® unit that is available from In-Line Automation of Minneapolis, Minn. The unit may use vacuum cylinders, belts or other suitable transfer means to transfer the individual segments to the web of material.

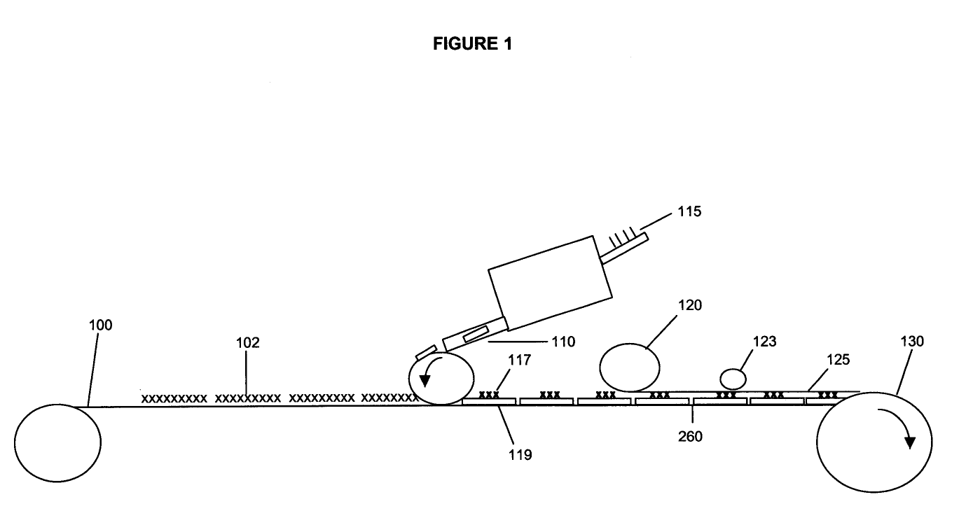

Reference is now directed to FIG. 1 which provides a schematic of an apparatus that may be used to carry out the present invention and create the intermediate, glossy prime label assembly. The apparatus is one preferably used for handling a continuous web which is referenced by numeral 100. The web 100 is coated with a pattern of adhesive 102 which is applied over the surface of a release material such as silicone (not shown). The web 100 is advanced to a placer mechanism 110 which is used to sequentially place a series of preprinted prime label ribbon segments that are supplied to the placer mechanism 110 via a hopper 115 or other suitable feeding means. The placer 110 sequentially places each of the segments on the web and produces a regular, repeating pattern as is shown on the web at 119. As previously mentioned, each of the segments has printing 117 applied to the segments. The printing or imaging having been applied by the high resolution imaging device prior to being placed in the hopper 115 of the placer 110.

The web 119 with the segments applied over the adhesive continually advances in a machined direction. Next, a polyethylene clear film supplied from a source 120 is placed over the individual segments shown at 125 to provide the label segments with a glossy finish and protective covering. The film is affixed to the segments through use of a heated roller 123 which effectively seals the film (by activation of adhesive or shrinking) onto the label segments. The label segments are then collected at step 130 by a rewinder or other suitable collecting device.

It should be understood that the film may be applied as shown in the schematic from a continual source, or a second placer mechanism may be used to place individual film pieces, that are sized and configured to be approximately the same size as the label segments. In a still further alternative, the film may be applied to the individual segments, prior to being placed in the hopper for the placer mechanism.

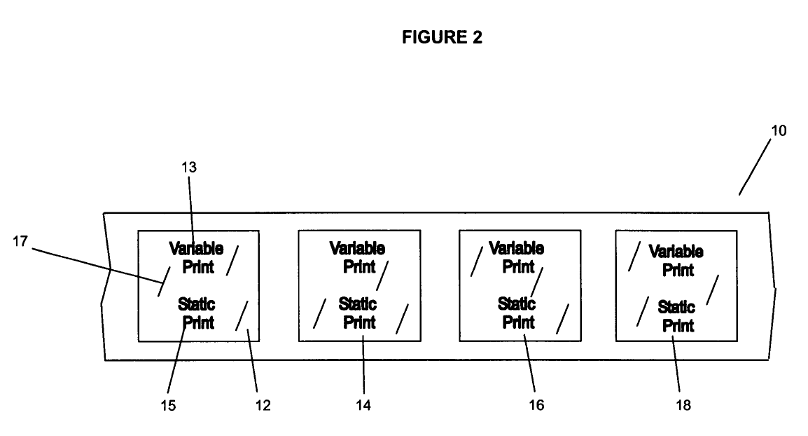

FIG. 2 shows a top view of a section of a web intermediate assembly having a regularly occurring series of prime label intermediates applied thereto. The web 10, is shown with glossy prime label segments 12, 14, 16 and 18. Each of the label segments has been shown with both variable printing 13 and static or fixed printing 15. As has been previously discussed, the unique system described herein allows the manufacturer to apply any sort of indicia to the surface of the prime label intermediates prior to the label segments being supplied to the carrier web. Each of the label segments is also provided with a transparent film, represented by dashed lines 17.

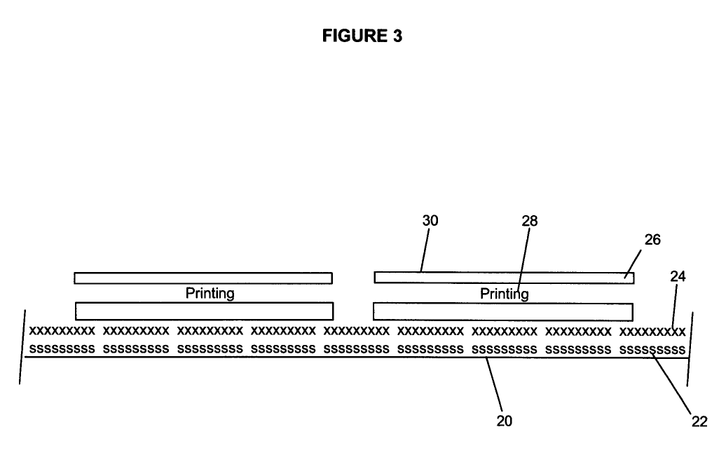

FIG. 3 is provided to show a cross section of the web intermediate assembly of the present invention. The assembly includes a carrier web 20 that has been coated with a release material 22 over which a pattern of adhesive 24 has been applied. Each of the individual label segments 26 are applied over the adhesive 24. In the event that adhesive remains exposed, it can be deadened or otherwise treated so that the adhesive does not interfere with the processing of the web of material.

As shown in FIG. 3, each of the label segments 26 has been provided with printing 28, which again has been applied prior to the label segment being supplied to the web 20. The printing 28 is then covered with a clear film material 30, here shown as individual pieces sized and configured to cover the approximate area of the label segment material.

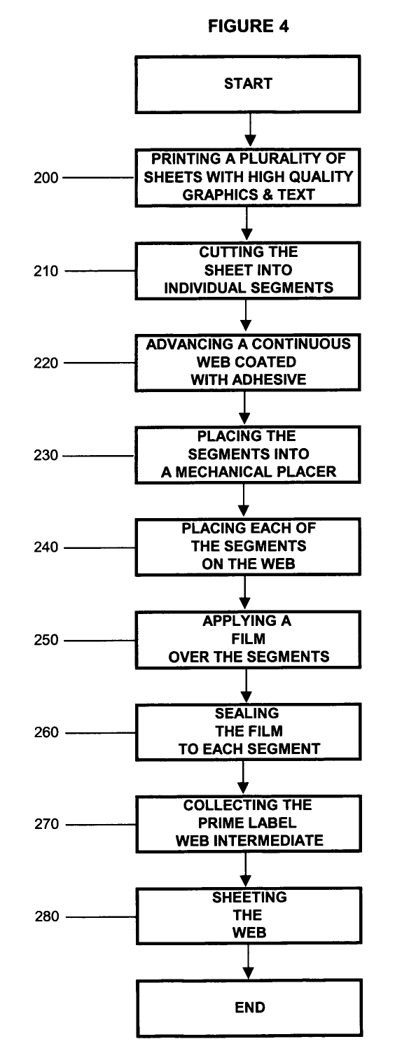

Turning now to FIG. 4, which provides a block diagram illustrating an exemplary method in carrying out the present invention. The process is begun by printing a series of sheets in discrete areas with graphic and textual information at step 200. Next, the sheets are cut into individual prime label segments at step 210. The cutting may be accomplished such as through use of a die cutting device, including a laser die cutter. Next, a continuous web is supplied at step 220. The web of material as previously mentioned is provided with a pattern of release and adhesive and is generally advanced in a machine direction (the direction the apparatus handles the web). The web has first and second longitudinally extending sides and the pattern of adhesive and release is applied between the sides of the web.

The individual segments are placed into a mechanical placer at step 230 and then the mechanical placer deposits the separate segments on the web at step 240 in a sequential fashion, so that they appear in a substantial edge-to-edge configuration creating a regularly repeating pattern of label segments on the web.

A clear film material is then placed over the segments at step 250 as to create a protective and glossy appearance on each of the label intermediates. The film is sealed to the surface of each of the label intermediates through use of a heated roller at step 260 and the web is collected at step 270. If desired, the web can be cut into individual sheets at step 280 so that each of the individual sheets has at least one glossy prime label intermediate thereon.

The carrier web used in the practice of the present invention functions similarly as a release liner, that is, the release coating is provided on the first face such that when an adhesive is applied, as has been described herein, the adhesive will transfer to the back of the label segments or sheets when the individual prime label intermediates are removed from the web. This will occur as the adhesive has a greater affinity for the label segments or sheets than for the carrier web as the label segments do not have a release coating applied to the surface in contact with the adhesive.

It will thus be seen according to the present invention a highly advantageous high quality glossy prime label intermediate has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A glossy prime label produced in accordance with the following process, including the steps of;
producing a plurality of individual sheets with areas having distinct graphical depictions provided on at least one face of each of said sheets;
advancing a continuous web having first and second faces and first and second longitudinally extending sides, a release coating is applied over said first face and a pattern of adhesive is applied over said release coating;
trimming each of said sheets to create at least one prime label segment from each sheet with each segment containing said distinct graphical depiction;
placing each segment on said pattern of adhesive in a substantially abutting edge-to-edge relationship and between said first and second longitudinally extending sides of said continuous web;
placing a synthetic film over each of said segments; and
sealing said film to each of said segments to create a continuous web having a regularly occurring series of glossy prime labels.

2. A glossy prime label as recited in claim 1, wherein the step of placing a synthetic film is practiced after the step of producing a plurality of individual sheets having distinct graphical depictions provided thereon.

3. A glossy prime label as recited in claim 1, wherein the step of sealing the film to each of said segments is practiced by using a heat sealing roller.

4. A glossy prime label as recited in claim 1, wherein said film is printed with additional graphical depictions prior to the step of placing said film.

5. A glossy prime label as recited in claim 4, wherein said graphical depictions on said film are complimentary to said graphical depictions on said segments.

6. A glossy prime label as recited in claim 1, wherein said film has at least one transparent portion and at least a translucent portion.

7. A glossy prime label as recited in claim 1, wherein said film is cut into individual strips sized and configured to fit over each of said segments.

8. A glossy prime label intermediate assembly produced in accordance with the following process;
printing a number of areas on individual sheets with distinct textual and graphical depictions;
applying a glossy film material over each of said sheets;
cutting each of said sheets into discrete ribbons, with each ribbon including at least one area, each ribbon having said distinct textual and graphical depictions from said sheet and each ribbon having a matrix portion and a prime label portion;
placing a group of said ribbons into a mechanical feeder;
advancing a continuous web, said web having a pattern of adhesive applied over a release coating;
applying each of said ribbons with said film thereon to said web sequentially and in contact with said adhesive;
collecting said web to create an intermediate glossy prime label web assembly having a discontinuous series of glossy prime labels disposed thereon.

9. A glossy prime label intermediate assembly as recited in claim 8, wherein said film is applied using a heated roller.

10. A glossy prime label intermediate assembly as recited in claim 8, wherein said film is preprinted with high resolution graphics that are complimentary to said textual and graphical depictions on said area of said sheets.

11. A glossy prime label intermediate assembly as recited in claim 8, wherein said film and said segments are each printed with high quality graphics having a resolution greater than about 150 lines per inch.

12. A glossy prime label intermediate assembly as recited in claim 8, wherein said intermediate glossy prime label web assembly is cut into individual sections, with each section containing at least one glossy prime label.

13. A glossy prime label intermediate assembly as recited in claim 8, wherein said ribbons are applied to said web in a substantial edge-to-edge configuration.

14. A glossy prime label intermediate assembly as recited in claim 8, wherein said web is a carrier web having release properties.

15. A prime label intermediate web assembly having intermittently positioned glossy prime label segments disposed thereon, comprising;
a continuous web of material, said web of material having a pattern of pressure sensitive adhesive disposed on a surface of said web;
a series of preprinted, individual segments having an area less than an area of said continuous web, said individual segments are placed on said continuous web over said pattern of adhesive in a discontinuous, incremental arrangement and in a substantially edge-to-edge relationship to one another; and
a glossy film stock affixed to a surface of each of said segments to produce a glossy prime label intermediate.

16. A prime label intermediate web assembly as recited in claim 15, wherein said continuous web serves as a carrier web having release properties.

17. A prime label intermediate web assembly as recited in claim 15, wherein said glossy film stock is partially preprinted prior to said film stock being affixed to each of said segments.

18. A prime label intermediate web assembly as recited in claim 15, wherein said glossy film stock is affixed to each of said segments through use of a heated roller assembly.

19. A prime label intermediate web assembly as recited in claim 15, wherein said segments are placed in a regularly occurring, repeating sequence.

20. A prime label intermediate web assembly as recited in claim 17, wherein each of said segments and said film is printed with a resolution of at least about 150 lines per inch.
